(19) United States
(12) Patent Application Publication
(10) Pub. No.: US 2025/0298413 A1
(43) Pub. Date: Sep. 25, 2025

(54) CART TRANSPORT APPARATUS

(71) Applicants: KABUSHIKI KAISHA TOSHIBA, Tokyo (JP); TOSHIBA INFRASTRUCTURE SYSTEMS & SOLUTIONS CORPORATION, Kawasaki-shi (JP)

(72) Inventor: Akihito TERADA, Yokohama (JP)

(73) Assignees: KABUSHIKI KAISHA TOSHIBA, Tokyo (JP); TOSHIBA INFRASTRUCTURE SYSTEMS & SOLUTIONS CORPORATION, Kawasaki-shi (JP)

(21) Appl. No.: 19/066,299

(22) Filed: Feb. 28, 2025

(30) Foreign Application Priority Data
Mar. 22, 2024 (JP) 2024-046488

(51) Int. Cl. G05D 1/246; B60B 19/00; B60B 33/00; B66F 9/06; B66F 9/075; G01C 21/00; G05D 105/28

(52) U.S. Cl. CPC G05D 1/246; B66F 9/063; B66F 9/0755; G01C 21/3841; B60B 19/003; B60B 33/006; G05D 2105/28

(57) ABSTRACT

A cart transport apparatus according to an embodiment includes: a driving part including a plurality of omnidirectional wheels; a driven part including a fixing part configured to fix a cart, the driven part being coupled to the driving part; an information acquisition part configured to read information regarding the cart from an information storage part provided in the cart; and a controller configured to calculate, from the information regarding the cart read by the information acquisition part, a turning center of the cart transport apparatus in a state in which the cart is fixed.

### CROSS-REFERENCE TO RELATED APPLICATIONS

This application is based upon and claims the benefit of priority from the Japanese Patent Application No. 2024-046488, filed on Mar. 22, 2024; the entire contents of which are incorporated herein by reference.

### FIELD

Embodiments of the invention relate to a cart transport apparatus.

### BACKGROUND

In distribution bases, warehouses, factories, and so on, carts are used as implements for moving items. In recent years, unmanned cart transport apparatuses have been used for labor saving to transport carts loaded with items. For example, a cart transport apparatus that performs autonomous transportation has been proposed.

Since there are various patterns of the types and arrangements of the wheels of carts, it is difficult to transport the carts as desired.

### BRIEF DESCRIPTION OF THE DRAWINGS

FIG. 1 is a schematic diagram illustrating a cart transport apparatus according to an embodiment;

FIG. 2 is a control block diagram of the cart transport apparatus;

FIGS. 3A to 3C are schematic diagrams illustrating relationships between the turning center of the cart transport apparatus, and the types and arrangement of wheels; and

FIG. 4 is a schematic diagram illustrating transportation of carts in a distribution base.

### DETAILED DESCRIPTION

A cart transport apparatus according to an embodiment includes: a driving part including a plurality of omnidirectional wheels; a driven part including a fixing part configured to fix a cart, the driven part being coupled to the driving part; an information acquisition part configured to read information regarding the cart from an information storage part provided in the cart; and a controller configured to calculate, from the information regarding the cart read by the information acquisition part, a turning center of the cart transport apparatus in a state in which the cart is fixed.

Hereinafter, embodiments of the invention will be described with reference to the drawings. In the drawings, similar components are marked with like reference numerals, and a detailed description is omitted as appropriate.

Arrows X, Y, and Z in the drawings represent three directions orthogonal to each other. For example, the arrow X can be a direction (length direction) from a driving part 2 toward a driven part 3. For example, the arrow Y can be a direction (width direction) orthogonal to the direction from the driving part 2 toward the driven part 3. For example, the Z-direction can be a direction perpendicular to a plane that includes the ground contact positions of wheels 101 of a cart 100.

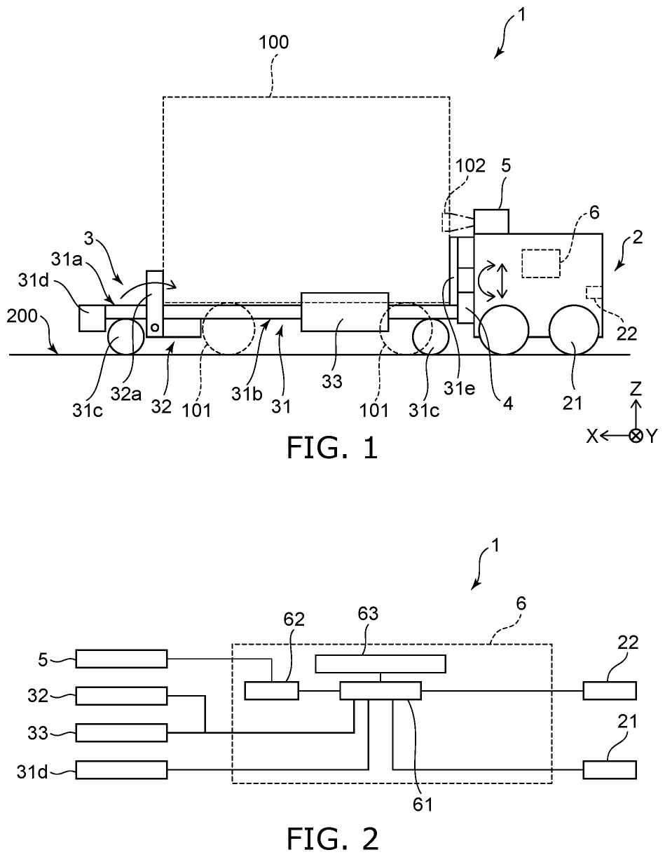

FIG. 1 is a schematic diagram illustrating a cart transport apparatus 1 according to an embodiment.

As illustrated in FIG. 1, the cart transport apparatus 1 includes, for example, the driving part 2, the driven part 3, a coupling part 4, an information acquisition part 5, and a controller 6.

The driving part 2 can be, for example, an AMR (Autonomous Mobile Robot) or an AGV (Automatic Guided Vehicle). The AMR has, for example, a SLAM (Simultaneous Localization and Mapping) function to create a surrounding environment map and estimate its own position and to transport the cart 100 to the destination while searching for the transport route. The AMR is also referred to as, for example, an autonomous traveling transport robot. The AGV reads a transport route from, for example, a magnetic tape or a marker attached to, for example, the traveling surface, such as the floor, and transports the cart 100 to the destination with autonomous moving. The AGV is also referred to as, for example, an unmanned transport vehicle.

Note that the driving part 2 is not limited to the AMR or the AGV, and may be anything that enables unmanned transportation of the cart 100. The driving part 2 needs to be an automated traveling vehicle that can be used in automated transportation.

The cart 100 can be, for example, a mesh cart (also referred to as, for example, a roll box pallet) or a flat cart. The mesh cart is generally a wheeled pallet having mesh walls on three sides. The flat cart is a wheeled pallet without a mesh wall. Therefore, in consideration of transporting a large number of items in a stable state, the cart 100 transported by the cart transport apparatus 1 is preferably a mesh cart. However, the cart transport apparatus 1 can also transport a flat cart.

The driving part 2 includes, for example, a plurality of omnidirectional wheels 21 and a detector 22 (corresponding to an example of a first detector).

Each omnidirectional wheel 21 includes, for example, a wheel, such as a mecanum wheel or an omni wheel, and an actuator (motor) that drives the wheel.

The controller 6 described below can drive each of the plurality of omnidirectional wheels 21 by, for example, controlling the actuator provided in each of the plurality of omnidirectional wheels 21. That is, the controller 6 can perform all-wheel drive of the plurality of omnidirectional wheels 21.

Since the plurality of omnidirectional wheels 21 can move in all directions, transportation of the cart 100 in a narrow space becomes easy. Further, even when the turning center of the cart transport apparatus 1 changes due to the types or arrangement of the wheels provided to the cart 100, the cart transport apparatus 1 smoothly turn in accordance with the turning center.

The detector 22 measures the surrounding environment. The detector 22 can be, for example, a laser range sensor. The controller 6 creates a surrounding environment map and estimates its own position, based on information from the detector 22. That is, the detector 22 can be used in running of the cart transport apparatus 1 (the plurality of omnidirectional wheels 21).

The driven part 3 is coupled to the driving part 2 via the coupling part 4.

The driven part 3 includes, for example, a loading platform 31, a fixing part 32, and a moving part 33.

The loading platform 31 can be, for example, a framed body having a framework structure.

The distance between a floor 200, which is the traveling surface, and a surface 31a of the loading platform 31 opposite to the floor 200 (the height of the loading platform 31) is smaller than the distance between the floor 200 and a surface of the cart 100 facing the floor 200. Therefore, the loading platform 31 can move into the space between the cart 100 and the floor 200.

The size of the loading platform 31 in the X-direction (the length of the loading platform 31) is longer than the size of the cart 100 in the X-direction (the length of the cart 100). Therefore, when the loading platform 31 is moved into the space between the cart 100 and the floor 200, an end portion of the loading platform 31 opposite to the driving part 2 can be exposed from the cart 100.

The size of the loading platform 31 in the Y-direction (the width of the loading platform 31) is shorter than the size between the wheels 101 of the cart 100 in the Y-direction. Therefore, when the loading platform 31 is moved into the space between the cart 100 and the floor 200, the loading platform 31 can move through the space between the wheels 101 of the cart 100.

On a surface 31b of the loading platform 31 facing the floor 200, a plurality of wheels 31c are provided. For example, a pair of wheels 31c can be provided in the vicinity of an end portion of the loading platform 31 adjacent to the driving part 2 and in the vicinity of the end portion of the loading platform 31 opposite to the driving part 2. Each wheel 31c can be, for example, a swivel wheel (free wheel). Note that the number and arrangement of the wheels 31c can be changed as appropriate in accordance with the length and width of the loading platform 31.

Further, a detector 31d (corresponding to an example of a second detector) can be provided at the end portion of the loading platform 31 opposite to the driving part 2. To allow the loading platform 31 to move into the space between the cart 100 and the floor 200, the cart 100, which is a transportation target, needs to be detected. Further, when the loading platform 31 is moved into the space between the cart 100 and the floor 200, interference between the loading platform 31 and the wheels 101 of the cart 100 needs to be prevented. Therefore, the detector 31d detects the positions of the cart 100 and the wheels 101 of the cart 100. The detector 31d is not limited to a specific one as long as the positions of the cart 100 and the wheels 101 can be detected. The detector 31d can be, for example, an optical sensor or a laser range sensor.

As described above, since the loading platform 31 moves into the space between the cart 100 and the floor 200, there is a gap between the loading platform 31 and the cart 100. Therefore, the fixing part 32 is provided to fix the cart 100 to the loading platform 31.

The fixing part 32 includes, for example, a swing arm 32a. When the loading platform 31 is moved into the space between the cart 100 and the floor 200, the distal end of the swing arm 32a is positioned between the surface 31a of the loading platform 31 and the floor 200. When the cart 100 is fixed, the swing arm 32a is rotated so that the swing arm 32a presses the cart 100 toward the driving part 2, as illustrated in FIG. 1. Since the cart 100 is provided with the wheels 101, the cart 100 pressed by the 30 swing arm 32a moves toward the driving part 2. The cart 100 is sandwiched and fixed between the swing arm 32a and an end portion 31e of the loading platform 31 adjacent to the driving part 2.

In this case, the cart 100 fixed to the loading platform 31 35 is in contact with the floor 200 and self-standing. That is, the cart transport apparatus 1 is not provided with a lifter that lifts the cart 100 from the floor 200 and fixes the cart 100. Therefore, the manufacturing costs of the cart transport apparatus 1 can be reduced. Further, since the plurality of wheels 101 provided to the cart 100 are in contact with the floor 200, the position of the cart 100 can be stabilized. Therefore, the cart 100 can be transported in a stable state.

The moving part 33 moves the position of the fixing part 32 (the swing arm 32a) in the X-direction. If the position of the fixing part 32 can be moved by the moving part 33, it is possible to respond to a change in the size of the cart 100 in the X-direction. Therefore, the number of types of carts 100 that can be handled can be increased.

The coupling part 4 is provided between the driving part 2 and the driven part 3. The coupling part 4 absorbs a positional shift between the driving part 2 and the driven part 3 in the Z-direction. The coupling part 4 absorbs an angular shift between the driving part 2 and the driven part 3 about the Y-direction. The coupling part 4 can be one that includes, for example, a linear guide and a bush. As long as the coupling part 4 is provided, even if the floor 200 is uneven, each of the driving part 2 and the driven part 3 can come into contact with the floor 200, which allows smooth movement of the cart transport apparatus 1.

There are various types of carts 100. For example, even the carts 100 of the same mesh type may differ in the size of the mesh cart 100 in the X-direction, the types of wheels (swivel wheels (free wheels) 101a and fixed wheels 101b) provided to the cart 100, the arrangement of the wheels, and so on.

For example, when the size of the cart 100 in the X-direction changes, the position at which the cart 100 is pressed by the swing arm 32a changes.

Further, the turning center of the cart transport apparatus 1 in a state in which the cart 100 is fixed differs depending on the types of wheels or the arrangement of the wheels provided to the cart 100.

Therefore, the cart transport apparatus 1 is provided with the information acquisition part 5. The information acquisition part 5 reads information regarding the cart 100 from an information storage part 102 provided in the cart 100.

The information storage part 102 can store information regarding the cart 100 as, for example, a one-dimensional code or a two-dimensional code. In this case, the information acquisition part 5 may be, for example, a bar code reader.

The information storage part 102 may be one that includes, for example, a semiconductor memory storing information regarding the cart 100. In this case, the information acquisition part 5 can read the information regarding the cart 100 stored in the information storage part 102 through, for example, wireless communication.

The information regarding the cart 100 includes, for example, the size of the cart 100 in the X-direction, the types of wheels (the swivel wheels 101a and the fixed wheels 101b) provided to the cart 100, the arrangement of the wheels, and so on described above.

The information regarding the cart 100 may be ID information of the cart 100. In this case, information associated with the ID information, such as the size of the cart 100 in the X-direction, the types of wheels provided to the cart 100, and the arrangement of the wheels, is stored on, for example, an information device provided externally to the cart transport apparatus 1.

As illustrated in FIG. 1, the information storage part 102 can be provided, for example, at one end portion of the cart 100 in the X-direction. The information acquisition part 5 needs to be provided at a position at which information can be read from the information storage part 102. For example, the information acquisition part 5 can be provided at an end portion of the driving part 2 on a side opposite to the floor 200.

The controller 6 controls the motion of each component provided in the cart transport apparatus 1.

FIG. 2 is a control block diagram of the cart transport apparatus 1.

As illustrated in FIG. 2, the controller 6 includes, for example, a control unit 61, a cart information management unit 62, and an interface 63.

The control unit 61 is electrically connected to, for example, the cart information management unit 62, the interface 63, the omnidirectional wheels 21, the detector 22, the fixing part 32, the moving part 33, and the detector 31d.

The cart information management unit 62 is electrically connected to, for example, the information acquisition part 5.

An operator of the cart transport apparatus 1 can input information, such as a transport destination, to the control unit 61 via the interface 63. The control unit 61 drives each of the plurality of omnidirectional wheels 21, based on the input information, such as the transport destination, and information from the detector 22 to run the cart transport apparatus 1. Since a known technique can be applied to the running control in the AMR or the AGV, a detailed description is omitted.

Therefore, a case will be described below where the controller 6 controls the motion of each component provided in the cart transport apparatus 1 based on the information regarding the cart 100 acquired by the information acquisition part 5.

First, the controller 6 (the control unit 61) controls the driving part 2 (the actuators of the omnidirectional wheels 21) to move the loading platform 31 into the space between the cart 100 and the floor 200. At this time, the control unit 61 recognizes the cart 100, which is a transportation target, based on information from the detector 31d. Further, the control unit 61 controls the motion of the omnidirectional wheels 21, based on information from the detector 31d so that the loading platform 31 does not interfere with the wheels 101 of the cart 100.

As described above, the information storage part 102 is provided at the one end portion of the cart 100 in the X-direction. Therefore, when the loading platform 31 is moved into the space between the cart 100 and the floor 200, the information acquisition part 5 can be opposed to the information storage part When the information acquisition part 5 faces the 102. information storage part 102, the information acquisition part 5 can read information from the information storage part 102.

When the information acquisition part 5 fails to read the information, the control unit 61 controls the omnidirectional wheels 21 to pull out the loading platform 31 from the cart 100 and moves the loading platform 31 into the space between the cart 100 and the floor 200 again from the opposed side (the opposite side) of the cart 100.

The information read from the information storage part 102 by the information acquisition part 5 is stored in, for example, the cart information management unit 62. As described above, the information regarding the cart 100 includes, for example, the size of the cart 100 in the X-direction, the types of wheels provided to the cart 100, the arrangement of the wheels, and so on.

When the information regarding the cart 100 is the ID information of the cart 100, the cart information management unit 62 or the control unit 61 makes an inquiry about the information regarding the cart 100 via the interface 63 to, for example, an information device provided externally to the cart transport apparatus 1. The information regarding the cart 100 acquired from, for example, the information device via the interface 63 is stored in, for example, the cart information management unit 62.

Next, the control unit 61 controls the fixing part 32 to fix the cart 100 to the loading platform 31. For example, the control unit 61 rotates the swing arm 32a and fixes the cart 100 so as to be sandwiched between the swing arm 32a and the end portion 31e of the loading platform 31 adjacent to the driving part 2.

As described above, there are various types of carts 100. For example, even the carts 100 of the same mesh type may differ in the size of the cart 100 in the X-direction. If the size of the cart 100 in the X-direction differs, the swing arm 32a may be unable to rotate or the cart 100 may be unable to be fixed by the swing arm 32a.

Therefore, the control unit 61 controls the moving part 33 based on the information regarding the size of the cart 100 in the X-direction (the length of the cart 100) read by the information acquisition part 5 to move the swing arm 32a to a position corresponding to the size of the cart 100 in the X-direction.

Accordingly, even if the size of the cart 100 in the X-direction changes, the cart 100 can be fixed to the loading platform 31.

Further, as described above, even the carts 100 of the same mesh type may differ in the types of wheels provided to the cart 100 or the arrangement of the wheels. When the types of wheels provided to the cart 100 or the arrangement of the wheels differ, the turning center of the cart transport apparatus 1 in a state in which the cart 100 is fixed differs.

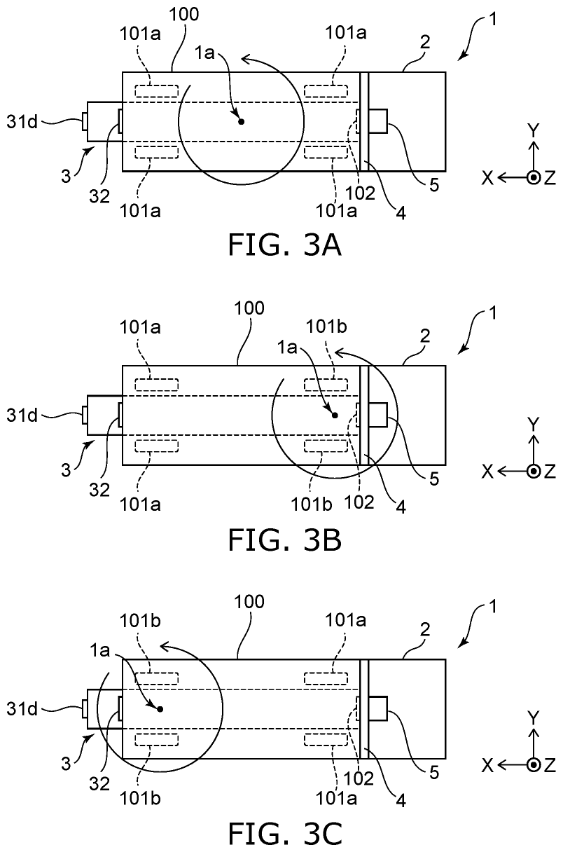

FIGS. 3A to 3C are schematic diagrams illustrating relationships between the turning center of the cart transport apparatus 1, and the types and arrangement of wheels.

As described above, the driving part 2 is provided with the omnidirectional wheels 21 capable of turning in any direction. Therefore, a turning center 1a of the cart transport apparatus 1 in a state in which the cart 100 is fixed can be the turning center of the cart 100.

As illustrated in FIG. 3A, the four wheels provided to the cart 100 may be the swivel wheels 101a. In such a case, the controller 6 (the control unit 61) can set the center position of the four swivel wheels 101a when viewed from a direction (for example, the Z-direction) perpendicular to a plane that includes the ground contact positions of the four swivel wheels 101a, as the turning center 1a of the cart transport apparatus 1 in a state in which the cart 100 is fixed. Note that the center position of the four swivel wheels 101a can be, for example, the center of a line segment connecting the center between the pair of swivel wheels 101a on a side facing the driving part 2 and the center between the pair of swivel wheels 101a on a side opposite to the driving part 2.

As illustrated in FIGS. 3B and 3C, the cart 100 may be provided with the pair of swivel wheels 101a and the pair of fixed wheels 101b. In such a case, the controller 6 (the control unit 61) can set the center position of the pair of fixed wheels 101b when viewed from a direction (for example, the Z-direction) perpendicular to a plane that includes the ground contact positions of the pair of fixed wheels 101b and the pair of swivel wheels 101a, as the turning center 1a of the cart transport apparatus 1 in a state in which the cart 100 is fixed.

Accordingly, even if the types of wheels and the arrangement of the wheels in the cart 100 change, the cart transport apparatus 1 can stably turn along the transport route.

The above is a case where the cart 100 includes rotating bodies (for example, the wheels 101 or spherical bodies) that make the cart 100 movable and where in a state in which the cart 100 is fixed to the fixing part 32 of the driven part 3, the rotating bodies of the cart 100 are in contact with the traveling surface with which the omnidirectional wheels 21 of the driving part 2 are in contact.

That is, this is a case where the turning center of the cart transport apparatus 1 is obtained in a state in which the cart 100 is fixed to the driven part 3, the driving part 2, the driven part 3, and the cart 100 are integrated, and the omnidirectional wheels 21 of the driving part 2 and the rotating bodies (for example, the wheels 101 or spherical bodies) of the cart 100 are in contact with the traveling surface.

However, in the embodiment, the same can be applied to a case where only the driving part 2 and the driven part 3 travel by rotating the wheels (the omnidirectional wheels 21 and the wheels 31c) in a state in which the rotating bodies (for example, the wheels 101 or spherical bodies) of the cart 100 are suspended above the traveling surface (for example, the floor 200). In this case, the cart transport apparatus 1 travels in a state in which the cart 100 is put on the loading platform 31 of the driven part 3 and carried.

In this case, if the cart 100 is heavy relative to the driven part 3, when the cart 100 is lifted by the driven part 3, the moment is suppressed more in rotation about the position of the center of gravity of the cart 100 than in turning about the position of the center of gravity of the driven part 3, which facilitates the turning or rotation.

In the embodiment, in addition to the omnidirectional wheels 21, for example, spherical bodies that make the driving part 2 movable can be used in the driving part 2.

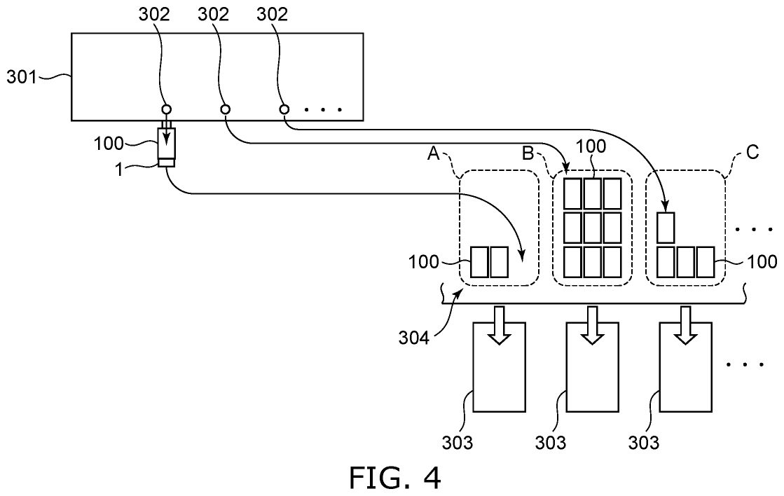

FIG. 4 is a schematic diagram illustrating transportation of the carts 100 in a distribution base.

As illustrated in FIG. 4, in the distribution base, items 302 are sorted by destination (for example, destinations A to C) by a sorting device 301. The items 302 sorted by destination are loaded onto the cart 100.

The cart 100 loaded with the items 302 is fixed to the cart transport apparatus 1 by following the above-described procedure. The turning center 1a of the cart transport apparatus 1 is set based on the types of wheels and the arrangement of the wheels provided to the cart 100.

The cart transport apparatus 1 moves to a truck-loading area 304 called a berth (cargo handling area) together with the fixed cart 100. Since the driving part 2 of the cart transport apparatus 1 can be, for example, an AMR or an AGV, the cart transport apparatus 1 can perform unmanned transportation of the cart 100 along the transport route. Further, since the turning center 1a of the cart transport apparatus 1 is set in accordance with the types of wheels and the arrangement of the wheels provided to the cart 100, stable turning along the transport route can be performed. Therefore, for example, the plurality of carts 100 are easily arranged by destination, namely, the destinations A to C, as illustrated in FIG. 4.

The carts 100 arranged by destination, namely, the destinations A to C, are loaded onto the loading platforms of vehicles 303, such as trucks, bound for the respective destinations. The carts 100 are loaded, for example, by the drivers who drive the respective vehicles 303.

In this case, when the pair of fixed wheels 101b of the cart 100 are made to face the vehicle 303, the driver can linearly move the cart 100 toward the loading platform of the vehicle 303. Therefore, the driver can easily load the cart 100 onto the vehicle 303.

In general, as illustrated in FIG. 4, a plurality of carts 100 are arranged by destination. Therefore, when the cart 100 is fixed to the cart transport apparatus 1, it is preferable that the fixed wheels 101b of the cart 100 be positioned on a side of the cart transport apparatus 1 opposite to the driving part 2. This makes it easy to arrange the plurality of carts 100 so that the pair of fixed wheels 101b of the carts 100 face the vehicle 303.

For example, when the pair of fixed wheels 101b is provided to the cart 100, it is preferable that the information storage part 102 be provided at an end portion of the cart 100 on a side opposite to the side on which the pair of fixed wheels 101b is provided in the X-direction. Accordingly, the information acquisition part 5 can be opposed to the information storage part 102, and simultaneously, the pair of fixed wheels 101b of the cart 100 can be positioned on the side of the cart transport apparatus 1 opposite to the driving part 2. Therefore, the transport efficiency of the cart 100 can be improved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. Moreover, above-mentioned embodiments can be combined mutually and can be carried out.

What is claimed is:

1. A cart transport apparatus comprising:
a driving part including a plurality of omnidirectional wheels;
a driven part including a fixing part configured to fix a cart, the driven part being coupled to the driving part;
an information acquisition part configured to read information regarding the cart from an information storage part provided in the cart; and
a controller configured to calculate, from the information regarding the cart read by the information acquisition part, a turning center of the cart transport apparatus in a state in which the cart is fixed.

2. The cart transport apparatus according to claim 1, wherein the cart includes a rotating body configured to make the cart movable, and in a state in which the cart is fixed to the fixing part, the rotating body is in contact with a traveling surface with which the omnidirectional wheels are in contact.

3. The cart transport apparatus according to claim 1, wherein the fixing part includes a swing arm configured to press the cart toward the driving part.

4. The cart transport apparatus according to claim 3, wherein
the driven part further includes a moving part configured to move a position of the swing arm,
the information regarding the cart includes information regarding a length of the cart, and
the controller is configured to control the moving part, based on the read information regarding the length of the cart, to move the swing arm to a position corresponding to the length of the cart.

5. The cart transport apparatus according to claim 1, wherein
the information regarding the cart includes information regarding a type of a wheel provided to the cart and an arrangement of the wheel, and
when the cart includes four swivel wheels,
the controller is configured to set a center position of the four swivel wheels when viewed from a direction perpendicular to a plane including ground contact positions of the four swivel wheels, as the turning center in a state in which the cart is fixed.

6. The cart transport apparatus according to claim 1, wherein
the information regarding the cart includes information regarding a type of a wheel provided to the cart and an arrangement of the wheel, and
when the cart includes a pair of fixed wheels and a pair of swivel wheels,
the controller is configured to set a center position of the pair of fixed wheels when viewed from a direction perpendicular to a plane including ground contact positions of the pair of fixed wheels and the pair of swivel wheels, as the turning center in a state in which the cart is fixed.

7. The cart transport apparatus according to claim 1, wherein
the driving part is an automated traveling vehicle, and
the driven part includes a movable loading platform.

8. The cart transport apparatus according to claim 1, wherein the driving part is an AMR (Autonomous Mobile Robot) or an AGV (Automatic Guided Vehicle).

9. The cart transport apparatus according to claim 1, wherein
the omnidirectional wheels include a wheel and an actuator configured to drive the wheel, and
the wheel is a mecanum wheel or an omni wheel.

10. The cart transport apparatus according to claim 9, wherein the controller is configured to further control the actuator provided in each of the plurality of omnidirectional wheels to drive each of the plurality of omnidirectional wheels.

11. The cart transport apparatus according to claim 1, further comprising:
a first detector configured to measure a surrounding environment, wherein
the controller is configured to further perform at least any of creation of a surrounding environment map and estimation of a position of the cart transport apparatus, based on information from the first detector.

12. The cart transport apparatus according to claim 11, wherein the controller is configured to further search for a transport route to a destination, based on the created surrounding environment map and the estimated position of the cart transport apparatus.

13. The cart transport apparatus according to claim 6, wherein a distance between a floor and a surface of the loading platform opposite to the floor is smaller than a distance between the floor and a surface of the cart facing the floor.

14. The cart transport apparatus according to claim 6, wherein a length of the loading platform is longer than a length of the cart.

15. The cart transport apparatus according to claim 6, wherein in a direction orthogonal to a direction from the driving part toward the driven part, a size of the loading platform is shorter than a size between wheels of the cart.

16. The cart transport apparatus according to claim 6, further comprising:
a second detector provided at an end portion of the loading platform opposite to the driving part, wherein
the second detector is configured to detect a position of the cart and a position of a wheel of the cart.

17. The cart transport apparatus according to claim 6, wherein
when the loading platform is moved into a space between the cart and a floor, a distal end of the swing arm is positioned between the floor and a surface of the loading platform opposite to the floor, and
when the cart is fixed, the swing arm rotates to press the cart toward the driving part.

18. The cart transport apparatus according to claim 2, wherein the cart is fixed between the swing arm and an end portion of the loading platform adjacent to the driving part.

19. The cart transport apparatus according to claim 18, wherein the fixed cart is self-standing on a wheel of the cart.

20. The cart transport apparatus according to claim 1, wherein
the information regarding the cart includes ID information of the cart, and
the ID information is associated with at least any of information regarding a length of the cart, information regarding a type of a wheel provided to the cart, and information regarding an arrangement of the wheel.
